(19) United States
(12) Patent Application Publication
(10) Pub. No.: US 2026/0173011 A1
(43) Pub. Date: Jun. 18, 2026

(54) IMS SESSION TERMINATION BASED ON IDENTITY OF VISITED NETWORK

(71) Applicant: T-Mobile USA, Inc., Bellevue, WA (US)

(72) Inventors: A. Karl Corona, Maple Valley, WA (US); Sean P. Hoelzle, Collegeville, PA (US); Subramania Kaushik, Bellevue, WA (US); Mehul Shah, Bellevue, WA (US); Romil Kumar Sood, Bothell, WA (US)

(21) Appl. No.: 18/979,211

(22) Filed: Dec. 12, 2024

(51) Int. Cl. H04W 60/06; H04L 65/1016; H04W 84/04

(52) U.S. Cl. CPC H04W 60/06; H04L 65/1016; H04W 84/042

(57) ABSTRACT

The present invention relates to a system and method for managing the deregistration of a User Equipment (UE) from an Internet Protocol Multimedia Subsystem (IMS) when the UE roams to a Non-Terrestrial Network (NTN) that does not support IMS. The system introduces a Roaming Orchestrator within the home network of the UE, which receives an indication that the UE is connected to a network lacking IMS support. Upon receiving this indication, the Roaming Orchestrator initiates standard message requests to deregister the UE from the IMS, thereby preventing unnecessary signaling traffic and reducing delays in message delivery. This method ensures efficient use of network resources and improves the reliability of communication services, particularly in time-sensitive scenarios such as emergency communications.

### BACKGROUND

The Internet Protocol Multimedia Subsystem (IMS) is a standardized architecture for delivering IP multimedia services, such as voice, video, and messaging, over both fixed and mobile networks. The registration of a user device within the IMS framework involves several key components, including the Home Subscriber Server (HSS) which stores subscriber-related information and authentication data, and the Call Session Control Functions (CSCF) which manage the session control and registration processes.

In the event that a UE does not properly deregister from an IMS network, such as may occur during a handover to a Non-Terrestrial Network (NTN) that does not support IMS, the network components may erroneously believe that the UE can receive IMS services. Consequently, the network's HSS and CSCF may still hold the UE's registration information, leading to the network attempting a Session Initiation Protocol (SIP) request for the delivery of services such as SMS, voice over IP (VoIP), or voice over LTE (VoLTE) communications. In such a scenario, the network will fail to deliver the communication, and may continue for a time to attempt delivery using IMS before using a failover method, such as using Non-Access Stratum (NAS) for SMS delivery. This failover mechanism ensures that the message is eventually delivered using the control plane, bypassing the need for an active IMS connection. However, the initial delivery attempt consumes network resources and introduces a delay before the failover to NAS occurs. This delay will impact time-sensitive situations such as receiving information from emergency services. Furthermore, repeated failed attempts can lead to unnecessary signaling traffic, potentially congesting the network and impacting overall performance.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flowchart describing a method of deregistering a UE from an IMS in accordance with the present technology.

FIG. 4 is a flowchart that illustrates the deregistration of a UE from an IMS in accordance with the present technology.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed system and method can reduce the delay in receiving messages associated with registering a user device (UE) with a non-terrestrial network that does not support an IP Multimedia Subsystem (IMS). A Roaming Orchestrator is introduced into the home network of the UE that receives an indication that the UE is connected to a network that does not support IMS. In response, the Roaming Orchestrator uses standard message requests to cause the deregistration of the UE from the IMS of the home network.

A Non-Terrestrial Network (NTN) refers to a communication network that relies on infrastructure not located near the Earth's surface. This typically includes satellite networks, high-altitude platform systems (HAPS), and other space-based or airborne communication systems. NTNs are used to provide connectivity in areas where terrestrial networks, such as those based on fiber optics or cell towers, are not feasible or cost-effective. They can be particularly useful for remote or rural areas, maritime and aviation communications, and for providing backup connectivity during natural disasters or other emergencies.

A UE may register to receive roaming service with a visited NTN that uses Non-Access Stratum (NAS) for communication delivery rather than IMS. Because the UE is no longer connected to the IMS services of the home network, it cannot properly signal to the home network to deregister the UE with respect to these services. Furthermore, there is no standardized method for a UE to preemptively deregister from IMS services before it begins to roam. As a result, the home network will continue to believe that the UE can be reached through IMS and will attempt to deliver communications (including SMS, VoIP, VoLTE, and other similar communications) through IMS. When such delivery fails, the network will wait until a timeout occurs before using a fallback method such as NAS. This introduces an unnecessary delay in mobile terminated message delivery while the network waits for the timeout to occur. This can be seen as especially critical in emergency situations, as the delay will also impact messages received during a text-to-911 session.

In one example of the disclosed technology, a home network includes a Roaming Orchestrator. When a UE connects to a visited network, such as a visited NTN, the home network receives an Update Location Request (ULR), originating from the visited network, at an edge agent such as a Diameter Edge Agent (DEA). The edge agent extracts the identity of the visited network from the ULR and determines that the visited network does not support IMS. The edge agent then sends the identity of the UE, which may comprise a copy of the ULR, to the Roaming Orchestrator for deregistration of the UE from the IMS. The Roaming Orchestrator then sends a Location Information Request (LIR) to the Home Subscriber Server (HSS) of the home network and receives a Location Information Answer (LIA), which includes the identity of the Serving Call Session Control Function (S-CSCF) that the UE is associated with in the HSS. The Roaming Orchestrator can then deregister the UE from the IMS by sending to the S-CSCF a Registration Termination Request (RTR) configured to deregister the UE and sending to the HSS a Server Assignment Request (SAR) configured to dissociate the UE from the S-CSCF in the records of the HSS. The S-CSCF may then send a confirmation, such as a Registration Termination Answer (RTA), and the HSS may also send a confirmation response, such as a Server Assignment Answer (SAA).

In one example of the disclosed technology, a visited network sends information about a roaming UE to a home network, and a Roaming Orchestrator analyzes the information to determine that the visited network does not support IMS. It then sends a request, such as an LIR, to the HSS identifying the UE and receives a response that identifies the name of an S-CSCF that is associated with the UE. The Roaming Orchestrator can then deregister the UE from the IMS by sending a request to the S-CSCF (such as a Registration Termination Request) and a separate request to the HSS (such as a Server Assignment Request) to end the IMS session of the UE in the home network. This prevents future mobile terminated messages from attempting to reach the UE using IMS and avoids the associated delay.

In one example of the disclosed technology, a Roaming Orchestrator receives information identifying a UE and an indication that the UE should be disconnected from IMS. The indication could be the reception of the UE information itself. The Roaming Orchestrator then sends a request to the S-CSCF to deregister the UE. The Roaming Orchestrator then sends a request to the HSS to dissociate the S-CSCF from the UE.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples. In particular, it can be appreciated that there are many conditions under which the Roaming Orchestrator as described can effect the deregistration of a UE, of which a roaming UE connecting to a visited network is one example.

### Wireless Communications System

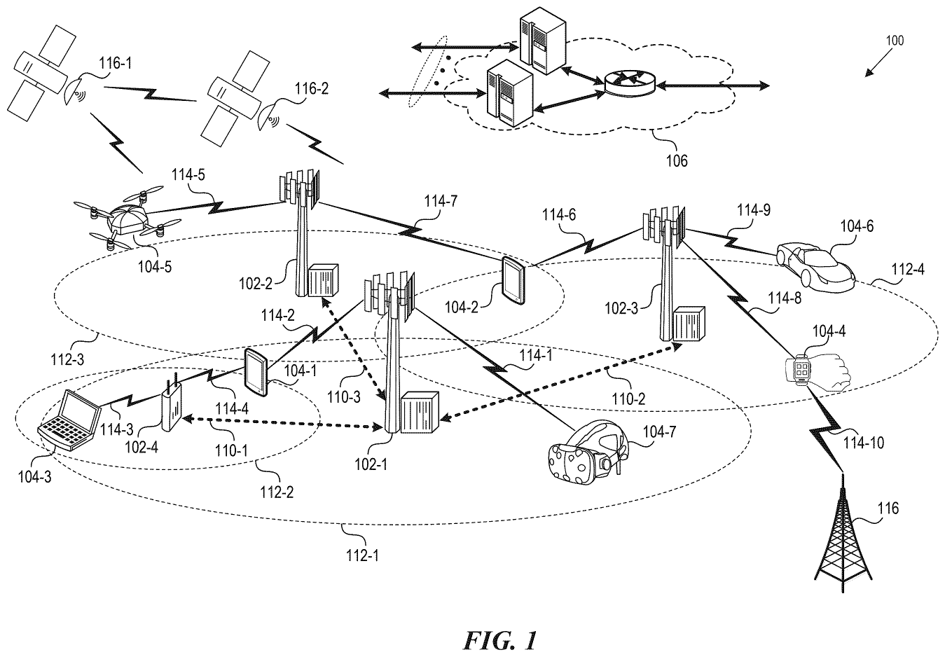

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

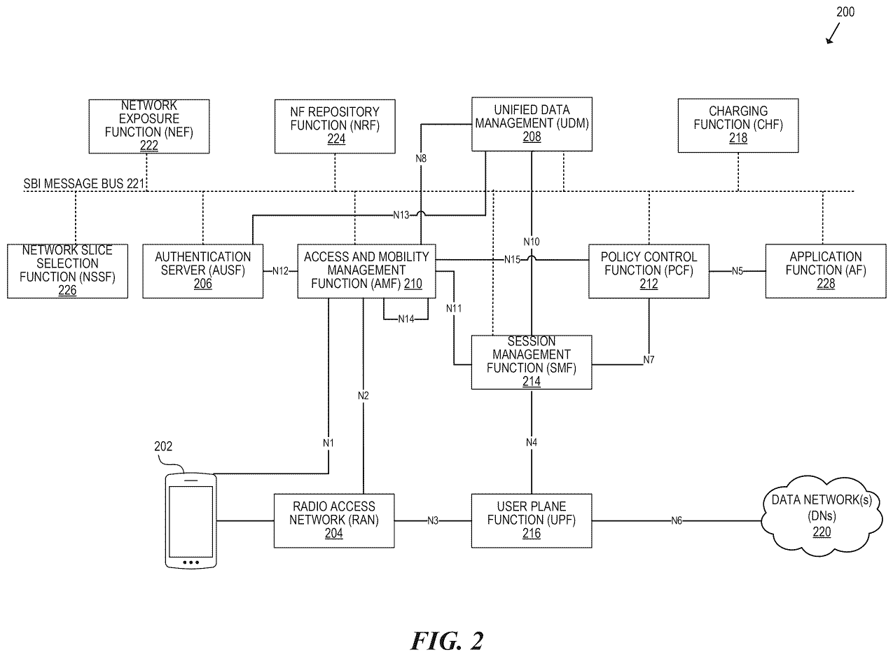

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### IMS Core Functions

When a user wishes to connect a UE to a home network using IMS, the UE will send a request to establish an IMS session, for instance a REGISTER request, which is received by a Proxy Call Service Control Function (P-CSCF). The P-CSCF will send a request to an appropriate Interrogatory CSCF (I-CSCF). The I-CSCF will request (e.g., interrogate) the Home Subscriber Server (HSS) of the network, for instance by sending a User Authorization Request (UAR), to receive information pertaining to the user and to the UE. This information may be included in a User Authorization Answer (UAA) and may include, for instance, the subscription status of the user and the capabilities of UE. The HSS will provide this information to the I-CSCF, which will use the information to choose an appropriate Serving CSCF (S-CSCF) to serve the UE. The S-CSCF then receives user information from the I-CSCF and sends a message, such as a Server Assignment Request (SAR), to the HSS declaring that it will serve the UE. Upon receipt of this declaration, the HSS records an association between the UE and the S-CSCF, and may respond with, for example, a Server Assignment Answer (SAA) including a subscriber profile of the user. Finally, the S-CSCF sends a message through the I-CSCF to the P-CSCF that includes information that identifies the S-CSCF. This may be included in a registration notification, such as a SIP NOTIFY.

For the remainder of the IMS session, when a user wishes to send a message, the UE will send the message to the P-CSCF, which in turn sends the message to the S-CSCF, which will then forward the message to the appropriate server for delivery. The appropriate server is often an Application Server (AS) designed for the delivery of multimedia services over IP networks. Conversely, when the home network receives a message that is designated to be delivered to the UE, known as a mobile terminated (MT) message, the network first retrieves information about the UE from the HSS. It uses the recorded association between the UE and the S-CSCF to deliver the message to the S-CSCF that serves the UE, which then delivers the message to the UE through a P-CSCF.

The IMS session is active as long as the HSS and S-CSCF maintain the registration information of the UE. This registration can be terminated by a deregistration request sent by the UE, for example if the UE is powering off or disconnecting from the home network. In addition, the network will periodically require the UE to re-register with the IMS. This may include the network re-authorizing and re-authenticating the UE. If the UE fails to re-register, the IMS session will be terminated, the HSS will dissociate the S-CSCF with the UE, and the S-CSCF will deregister the UE from itself. However, if the UE unexpectedly loses connection with the IMS and does not deregister from the IMS, the home network will still believe there is an active connection between the IMS and the UE and will continue to attempt delivery of incoming messages using the S-CSCF until such time as the UE fails to re-register.

A failure to deregister can occur when the UE roams to a visitor network that does not have an IMS, such as an NTN. An NTN may not offer IMS, and instead deliver communications by a different method, such as a Non-Access Stratum (NAS) system. If the UE roams to such a network, it could happen that the IMS components are not notified of the loss of connection between the UE and the IMS, and the UE cannot deregister itself as it can no longer access the IMS infrastructure. In such a scenario, the HSS will first attempt to route incoming messages to the UE through the S-CSCF. This will fail, but the home network will continue trying to deliver the message through the S-CSCF for a period of time before changing to a fallback method, such as NAS. This period of time becomes a delay for the user in receiving MT messages, and this delay will persist until enough time has passed for the network to require a re-registration. The re-registration will fail, and the home network will then automatically terminate the IMS session, disassociating the S-CSCF with the UE in the HSS and deregistering the UE with the S-CSCF.

### Roaming Orchestrator Method

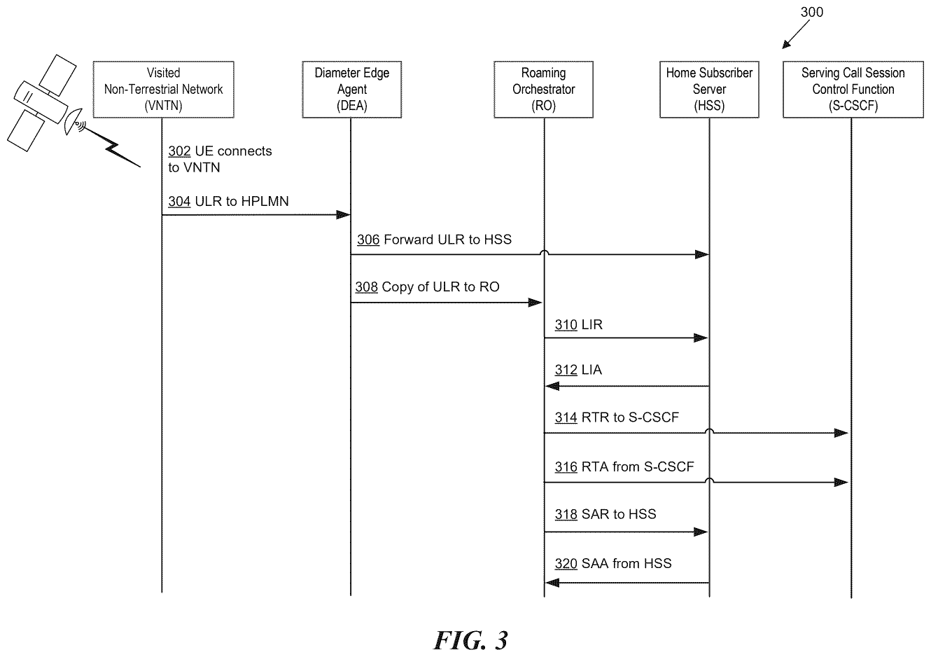

FIG. 3 is a flow diagram 300 that illustrates a method of deregistering a UE from the IMS of a HPLMN according to some embodiments of the present disclosure.

At 302, the UE connects to a Visited Non-Terrestrial Network (VNTN). In one example, the UE connects to the VNTN due to the UE leaving a geographic region in which the UE can connect to the HPLMN and is thus roaming in the VNTN. A VNTN is an example of a Visited Public Land Mobile Network (VPLMN). The technology as disclosed does not restrict the visited network to be a VNTN but can include VPLMNs that may or may not support IMS. In some embodiments, the UE connects to a VPLMN that is not a VNTN.

At 304, the VNTN sends an Update Location Request (ULR) to a Diameter Edge Agent (DEA) of the HPLMN to inform the HPMLN of the location of the UE. A DEA is an agent at the edge of a network that can communicate with other entities using the Diameter Protocol. The Diameter Protocol is a standardized message format that consists of a header followed by one or more Attribute-Value Pairs (AVPs). An AVP includes a header and is used to encapsulate protocol-specific data (e.g., routing information) as well as authentication, authorization, or accounting information (e.g., subscriber data, device identifiers, and the like). Many existing functions can be considered a DEA in a network, including Mobility Management Entities (MME), Serving Gateways (SGW), Packet Data Network Gateways (PGW), Serving PLMN Gateways (S-GW), or GPRS Support Nodes (SGSN). Alternately, a DEA can be a standalone function that connects to a VNTN and to a Diameter agent of an existing function, such as an MME. Furthermore, the reception of VNTN data may be performed by network elements other than a DEA, which may happen in network configurations which do not have a DEA, for example. In some embodiments, the ULR may be received by network elements that are not a DEA.

Additionally, the information received from the VNTN is not required to conform to the Diameter Protocol in all embodiments. The information received identifies the VNTN, for instance through a unique combination of Mobile Country Code (MCC) and Mobile Network Code (MNC). The information received further identifies the UE, for instance by a Mobile Station International Subscriber Directory Number (MSISDN) or International Mobile Subscriber Identity (IMSI) associated with the UE. In some embodiments, the network receives information from the VNTN that identifies the VNTN and the UE but does not conform to Diameter Protocol. In some embodiments, the network receives information from the VNTN that identifies the VNTN and the UE but is not in the format of a ULR.

The DEA determines that the UE will be deregistered from the IMS. In one embodiment, it uses the received ULR to determine that the VNTN does not support IMS. In some embodiments, the DEA contains a means of determining that the VNTN does not support IMS, such as a database storing the identities of Public Land Mobile Networks (PLMN), including VNTNs, that do not support IMS. In some embodiments, the DEA sends the identifying information to a server that responds with an indication that the VNTN does not support IMS. Furthermore, these actions may be performed by network elements other than a DEA. In some embodiments, a network element receives information identifying the VNTN and determines that the VNTN does not support IMS.

However, if the DEA determines that the visited network does support IMS, it may allow the home network to provide IMS service to the UE. In some embodiments, a system receives information originating from a visited network identifying a UE that is connected to the visited network, determines that the visited network supports an IMS, and responsive to the determination, provides IMS service to the UE.

At 306, the DEA forwards the ULR to the HSS. The ULR is accepted by the HSS, which updates the location information recorded in the HSS. This is not required in all embodiments because it is not directly related to IMS deregistration in the HPLMN. In some embodiments, the ULR is not sent to the HSS.

At 308, the DEA sends a copy of the ULR to the Roaming Orchestrator. In some embodiments, the Roaming Orchestrator will attempt to deregister the UE upon receipt of information that identifies the UE. In some embodiments, the Roaming Orchestrator receives a UE identifier and a command to deregister the UE, which may or may not originate from a DEA or VNTN. In some embodiments, the Roaming Orchestrator comprises the DEA and performs the above actions attributed to the DEA as part of this method.

At 310 the Roaming Orchestrator sends a Location Information Request (LIR) to the HSS. The LIR comprises information configured to request information about the UE from the HSS. The disclosed technology does not require this request be sent in the format of an LIR. In some embodiments, the Roaming Orchestrator sends a request in another format that is configured to return data associated with the UE.

At 312, HSS sends a Location Response Answer (LIA) to the Roaming Orchestrator. The LIA comprises information about the UE including information identifying the S-CSCF that the UE is registered with. The disclosed technology does not require that the response be in the format of an LIA. In some embodiments, the Roaming Orchestrator receives information in another format that is configured to include information identifying the S-CSCF that the UE is registered with.

At 314, the Roaming Orchestrator sends a Registration Termination Request (RTR) to the S-CSCF. The RTR is configured to deregister the UE from the S-CSCF. The disclosed technology does not require this request to be in the format of an RTR. In some embodiments, the Roaming Orchestrator sends a request in another format that is configured to deregister the UE from the S-CSCF.

At 316, the Roaming Orchestrator receives a Registration Termination Answer (RTA) from the S-CSCF. The disclosed technology does not require a response to be received from the S-CSCF, or that a response be in the format of an RTA.

At 318, the Roaming Orchestrator sends a Server Assignment Request (SAR) to the HSS. The SAR is configured to dissociate the S-CSCF and the UE in the records of the HSS. This can be done, for example, by configuring the RTR to conform to the Diameter Protocol, including information identifying the UE and the S-CSCF (e.g., as received in the LIA), and setting the Server-Assignment-Type attribute to the USER_DEREGISTRATION or ADMINISTRATIVE_DEREGISTRATION values. The disclosed technology does not require this request to be in the format of an SAR. In some embodiments, the Roaming Orchestrator sends a request in another format that is configured to dissociate the S-CSCF and the UE in the records of the HSS.

At 320, the Roaming Orchestrator receives a Server Assignment Answer (SAA) from the HSS. The disclosed technology does not require a response to be received from the HSS, or that a response be in the format of an SAA.

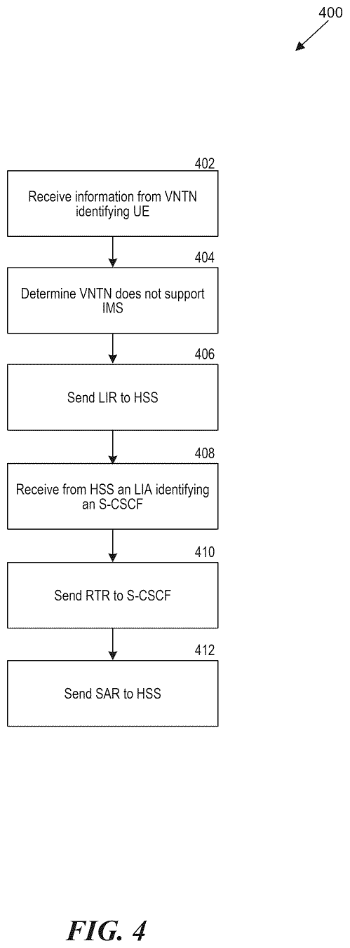

FIG. 4 illustrates a flowchart 400 method of deregistering a UE from an IMS in a home system, as performed by a computing system in the home network.

At 402, the system receives information originating from a Visited Non-Terrestrial Network (VNTN), which contains data identifying of the VNTN and data identifying a roaming user equipment (UE) that is connected to the VNTN. In some embodiments, the visited network is a Visited Public Land Mobile Network (VPLMN) that is not a Non-Terrestrial Network. This information can conform to a Diameter Protocol and identify the VNTN using an Attribute-Value Pair (AVP). This information can be received by the home network at a Diameter Edge Agent (DEA), which could be one of a Mobility Management Entity (MME), Serving Gateway (SGW), Packet Data Network Gateway (PGW), Serving PLMN Gateway (S-GW), or a GPRS Support Node (SGSN). This information can be received as an Update Location Request (ULR). The data identifying the UE can comprise at least one of an International Mobile Subscriber Identity (IMSI) or a Mobile Station International Subscriber Directory Number (MSISDN).

At 404, the system determines that the VNTN does not support an IP Multimedia Subsystem (IMS).

At 406, the system sends, to a Home Subscriber Server (HSS), a Location Information Request (LIR) that contains data identifying the UE. In some embodiments, the system sends a request to the HSS that is not in the LIR format.

At 408, the system receives, from the HSS, a Location Information Answer (LIA) that contains data identifying a Serving Call Session Control Function (S-CSCF) associated with the UE by the HSS. In some embodiments, the system receives information identifying the S-CSCF which is not in LIA format. In some embodiments, the system has access to the identity of the S-CSCF and does not send a request to the HSS (such as an LIR) nor receive information from the HSS (such as an LIA).

At 410, the system sends, to the S-CSCF, a Registration Termination Request (RTR) which is configured to deregister the UE from the S-CSCF. In some embodiments, the system sends a request that is configured to deregister the UE from the S-CSCF that is not in the RTR format. In some embodiments, the system receives a response from the S-CSCF, such as a Registration Termination Answer (RTA).

At 412, the system sends, to the HSS, a Server Assignment Request (SAR) that is configured to dissociate the S-CSCF and the UE. In some embodiments, the system sends a request that is configured to dissociate the S-CSCF and the UE that is not in the SAR format. In some embodiments, the system receives a response from the HSS, such as a Server Assignment Answer (SAA).

### Computer System

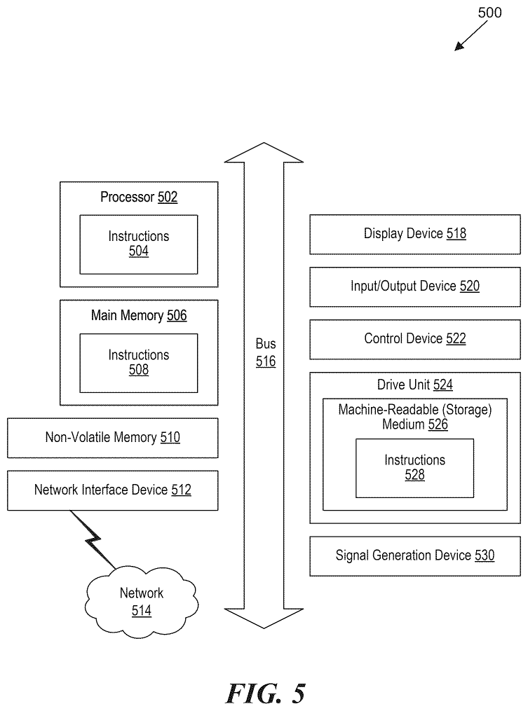

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system of a mobile telecommunications network comprising:
at least one hardware processor; and
at least one non-transitory memory storing instructions, which, when executed by the at least one hardware processor, cause the system to:
receive information originating from a Visited Non-Terrestrial Network (VNTN),
wherein the information contains data identifying of the VNTN and data identifying a roaming user equipment (UE) that is connected to the VNTN;
determine that the VNTN does not support an IP Multimedia Subsystem (IMS);
send, to a Home Subscriber Server (HSS), a Location Information Request (LIR),
wherein the LIR contains data identifying the UE;
receive, from the HSS, a Location Information Answer (LIA);
wherein the LIA contains data identifying a Serving Call Session Control Function (S-CSCF) associated with the UE by the HSS;
send, to the S-CSCF, a Registration Termination Request (RTR),
wherein the RTR is configured to deregister the UE from the S-CSCF;
receive, from the S-CSCF, a Registration Termination Answer (RTA);
send, to the HSS, a Server Assignment Request (SAR),
wherein the SAR is configured to dissociate the S-CSCF and the UE; and
receive, from the HSS, a Server Assignment Answer (SAA).

2. The system of claim 1, wherein the information originating from the VNTN conforms to a Diameter Protocol and identifies the VNTN using a value of an Attribute-Value Pair (AVP).

3. The system of claim 1, wherein the information originating from the VNTN is received as an Update Location Request (ULR) to the mobile telecommunications network.

4. The system of claim 1, wherein the data identifying the UE comprises at least one of an International Mobile Subscriber Identity (IMSI) or a Mobile Station International Subscriber Directory Number (MSISDN).

5. The system of claim 1, wherein the information originating from the VNTN is received at a Diameter Edge Agent (DEA).

6. The system of claim 1, wherein the determination that the VNTN does not support IMS is based on a list of networks stored in the at least one non-transitory memory.

7. At least one computer-readable medium, excluding transitory signals, carrying instructions that, when executed by a computing system of a telecommunications network, cause the computing system to perform operations comprising:
receiving information originating from a Visited Public Land Mobile Network (VPLMN) identifying a User Equipment (UE) that is connected to the VPLMN;
sending to a Home Subscriber Server (HSS) associated with the UE a Location Information Request (LIR);
receiving from the HSS a Location Information Answer (LIA) identifying a Serving Call Session Control Function (S-CSCF) that is associated with the UE by the HSS;
sending to the S-CSCF a Registration Termination Request (RTR) configured to deregister the UE from the S-CSCF;
receiving from the S-CSCF a Registration Termination Answer (RTA);
sending to the HSS a Server Assignment Request (SAR) configured to dissociate the S-CSCF and the UE; and
receiving from the HSS a Server Assignment Answer (SAA).

8. The at least one computer-readable medium of claim 7, wherein the VPLMN is a Non-Terrestrial Network.

9. The at least one computer-readable medium of claim 7, wherein the information originating from the VPLMN conforms to a Diameter Protocol.

10. The at least one computer-readable medium of claim 7, wherein the information originating from the VPLMN comprises an Update Location Request.

11. The at least one computer-readable medium of claim 7, wherein the information originating from the VPLMN identifies the UE using at least one of an International Mobile Subscriber Identity or a Mobile Station International Subscriber Directory Number.

12. The at least one computer-readable medium of claim 7, wherein the information originating from the VPLMN is received by a Diameter Edge Agent.

13. The at least one computer-readable medium of claim 7, wherein the instructions further comprise:
receiving information originating from a second VPLMN identifying a second UE that is connected to the second VPLMN;
determining that the second VPLMN supports an IP Multimedia Subsystem (IMS); and
responsive to the determination, providing IMS service to the second UE.

14. A method for operating a telecommunications network, the method comprising:
receiving, from a Visited Public Land Mobile Network (VPLMN), information identifying a User Equipment (UE) that is connected to the VPLMN;
receiving, from a Home Subscriber Server (HSS) associated with the UE, information identifying a Serving Call Session Control Function (S-CSCF) associated with the UE;
sending, to the S-CSCF, a request to deregister the UE from the S-CSCF; and
sending, to the HSS, a request to dissociate the S-CSCF and the UE.

15. The method of claim 14, wherein the VPLMN comprises a Non-Terrestrial Network (NTN).

16. The method of claim 14, wherein the information identifying a UE conforms to a Diameter Protocol.

17. The method of claim 14, wherein the information identifying a UE comprises an Update Location Request.

18. The method of claim 14, wherein the information identifying a UE comprises one of an International Mobile Subscriber Identity or a Mobile Station International Subscriber Directory Number.

19. The method of claim 14, wherein the information identifying a UE is received by a Diameter Edge Agent.

20. The method of claim 14, further comprising:
receiving, from a second VPLMN, information identifying a second UE that is connected to the second VPLMN;
determining that the second VPLMN supports an IP Multimedia Subsystem (IMS); and
responsive to the determination, providing IMS service to the second UE.
